(19) United States
(12) Patent Application Publication
(10) Pub. No.: US 2009/0155447 A1
(43) Pub. Date: Jun. 18, 2009

(54) Protein extrudates comprising omega-3 fatty acids

(75) Inventors: Joshua J. Moore, Belleville, IL (US); Santiago Solorio, Bridgeton, MO (US)

Correspondence Address: Solae, LLC, 4300 Duncan Avenue, Legal Department E4, St. Louis, MO, 63110, US

(73) Assignee: Solae, LLC, St. Louis, MO (US)

(21) Appl. No.: 11/955,117

(22) Filed: Dec. 12, 2007

(51) Int. Cl. A23J 3/26; A23J 3/00; A23J 3/16

(52) U.S. Cl. 426/656; 426/448

(57) ABSTRACT

The present invention relates to food materials containing a high concentration of vegetable protein and omega-3 fatty acids and processes for their manufacture. More particularly, the present invention relates to protein extrudates containing high concentrations of soy protein and omega-3 fatty acids, processes for manufacturing such protein extrudates, and the use of such protein extrudates as food ingredients.

### FIELD OF THE INVENTION

The present invention relates to food materials containing a high concentration of vegetable protein and omega-3 fatty acids and processes for their manufacture. More particularly, the present invention relates to protein extrudates containing high concentrations of vegetable protein and omega-3 fatty acids, processes for manufacturing such protein extrudates, and the use of such protein extrudates as food ingredients.

### BACKGROUND OF THE INVENTION

Texturized protein products are known in the art and are typically prepared by heating a mixture of protein material along with water under mechanical pressure in a cooker extruder and extruding the mixture through a die. Upon extrusion, the extrudate generally expands to form a fibrous cellular structure as it enters a medium of reduced pressure (usually atmospheric). Expansion of the extrudate typically results from inclusion of soluble carbohydrates which reduce the gel strength of the mixture.

Increased consumption of omega-3 fatty acids is recommended by the American Heart Association and other organizations, particularly for people at risk of cardiovascular disease. However, incorporating omega-3 fatty acids in food products, particularly in extruded food products, is difficult due to the fast rate of oxidation for the highly unsaturated omega-3 fatty acids.

### SUMMARY OF THE INVENTION

Among the various aspects of the invention are protein extrudates containing high concentrations of vegetable protein and omega-3 fatty acids.

Another aspect of the invention is a protein extrudate comprising at least 50 wt. % vegetable protein on a moisture-free basis, and from about 5 wt. % to about 15 wt. % oil on a moisture-free basis. The oil comprises at least 10 wt. % of the at least one omega-3 fatty acid based upon the total weight of fatty acids or derivatives thereof in the oil and the extrudate has a density from about 0.02 to about 0.5 g/cm³.

A further aspect is a protein extrudate comprising at least 50 wt. % vegetable protein on a moisture-free basis, and at least 10 wt. % oil on a moisture-free basis. The oil comprises at least 10 wt. % of the at least one omega-3 fatty acid based upon the total weight of fatty acids or derivatives thereof in the oil, the extrudate has a density from about 0.02 to about 0.5 g/cm³ and a hardness from about 7,000 to about 30,000 grams as measured by a texture analyzer having a 25 kg load cell.

Yet another aspect of the invention is a food product comprising the protein extrudates described above. These food products can be snack foods, snack puffs, or breakfast cereals.

Another aspect is a method of making a protein extrudate comprising mixing vegetable protein, an oil comprising at least 10 wt. % of at least one omega-3 fatty acid based upon the total weight of fatty acids or derivatives thereof in the oil, and water in an extruder to form a mixture; pressurizing the mixture in the extruder to a pressure of at least about 400 psi to form a pressurized mixture; heating the pressurized mixture in the extruder to a temperature of at least 35° C. to form a heated and pressurized mixture; extruding the heated and pressurized mixture through an extruder die to a reduced pressure environment to expand the mixture and form an extrudate; cutting the extrudate into a plurality of pieces; and drying the pieces to a water content of from about 1 wt. % to about 7 wt. % to form the protein extrudate having a density from about 0.02 g/cm³ to about 0.5 g/cm³ based on the weight of the protein extrudate and comprising from about 50 wt. % to about 85 wt. % protein.

Other objects and features will be in part apparent and in part pointed out hereinafter.

### DESCRIPTION OF THE DRAWINGS

FIG. 1 is a schematic flow diagram of a process useful in preparing the protein extrudates of the present invention.

### DETAILED DESCRIPTION

In accordance with the present invention, it has been discovered that textured protein products containing high concentrations of protein, low concentrations of carbohydrates, and oil sources predominantly comprising omega-3 fatty acids can be manufactured to have a desired density, acceptable texture, and acceptable flavor and odor stability using extrusion technology. Such protein extrudates can be formed as “nuggets” (also known as crisps such as in Rice Krispies cereal) or pellets for use as an ingredient or source of protein in health and nutrition bars, snack bars and ready to eat cereal. Alternatively, the protein extrudates may be further processed for use as a binder, a stabilizer, or a source of protein in beverages, health and nutrition bars, dairy, and baked and emulsified/ground meat food systems. In certain embodiments, the protein extrudates may be ground into fine particles (i.e., powder) to allow for incorporation into beverages. Such ground particles typically have a particle size of from about 1 μm to about 5 μm to allow suspension in a liquid.

In some embodiments, these extrudates are prepared using an emulsion containing an oil predominantly comprising omega-3 fatty acids. It has been discovered that when the oil added to a composition for forming a protein extrudate is an oil emulsion, the protein extrudate has a lower density and more acceptable sensory characteristics, such as odor, flavor and texture, as compared to the same composition including an unemulsified oil. These improvements are observed immediately after drying and after storage. In other embodiments, the oil need not be emulsified to form an acceptable protein extrudate comprising an omega-3 fatty acid.

A process of the present invention for preparing protein extrudates generally comprises forming a pre-conditioned feed mixture (e.g., a protein source, an optional carbohydrate source, and an emulsified form of an oil comprising at least one omega-3 fatty acid) by contacting the feed mixture with moisture, introducing the pre-conditioned feed mixture into an extruder barrel, heating the pre-conditioned feed mixture under mechanical pressure to form a molten extrusion mass, and extruding the molten extrusion mass through a die to produce a protein extrudate. This process provides a protein extrudate wherein the oil comprising at least one omega-3 fatty acid is incorporated within the extrudate. These extrudates do not have the oil added to the surface of the extrudate.

### Omega-3 Sources

Omega-3 fatty acids are a family of polyunsaturated fatty acids that have a carbon-carbon double bond in the ω-3 position. A table of omega-3 fatty acids follows.

| Common name | Lipid name | Chemical name |
|---|---|---|
| α-Linolenic acid (ALA) | 18:3 (n-3) | octadeca-9,12,15- |
| | | trienoic acid |
| Stearidonic acid | 18:4 (n-3) | octadeca-6,9,12,15- |
| | | tetraenoic acid |
| Eicosatetraenoic acid | 20:4 (n-3) | eicosa-8,11,14,17- |
| | | tetraenoic acid |
| Eicosapentaenoic acid (EPA) | 20:5 (n-3) | eicosa-5,8,11,14,17- |
| | | pentaenoic acid |
| Docosapentaenoic acid | 22:5 (n-3) | Docosa-7,10,13,16,19- |
| | | pentaenoic acid |
| Docosahexaenoic acid (DHA) | 22:6 (n-3) | Docosa-4,7,10,13,16,19- |
| | | hexaenoic acid |

The omega-3 fatty acids, particularly EPA and DHA, are most commonly found in cold water oily fish such as wild salmon, herring, mackerel, anchovies and sardines. The oil from these fish have a profile of around seven times more omega-3 fatty acids than omega-6 fatty acids. Farmed salmon, being grain fed, have a higher proportion of omega-6 fatty acids than wild salmon. Other oily fish such as tuna also contain omega-3 fatty acids in somewhat lesser amounts. Various plant sources of omega-3 fatty acids, particularly ALA, are chia (64%), kiwifruit (62%), perilla (58%), flax or linseed (55%), lingonberry (49%), camelina (36%), and purslane (35%).

In various embodiments, the oil comprises a preparation of substantially unsaturated fats or substantially unsaturated oils. Fats and oils comprise monoglycerides, diglycerides, triglycerides, and free fatty acids. The glycerides of fats and oils generally comprise fatty acids that are at least 4 carbons in length, and more preferably, unsaturated fatty acids that range in length from 16 to 22 carbons.

The polyunsaturated fatty acid can also be an omega-6 fatty acid, in which a carbon-carbon double bond occurs in the ω-6 position. Examples of omega-6 fatty acids include linoleic acid (18:2), gamma-linolenic acid (18:3), eicosadienoic acid (20:2), dihomo-gamma-linolenic acid (20:3), arachidonic acid (20:4), docosadienoic acid (22:2), adrenic acid (22:4), and docosapentaenoic acid (22:5). The fatty acid may also be an omega-9 fatty acid, such as oleic acid (18:1), eicosenoic acid (20:1), mead acid (20:3), erucic acid (22:1), and nervonic:acid (24:1).

In some embodiments, the oil can be a seafood-derived oil. The seafood can be a vertebrate fish or a marine organism, such as a fish oil or a marine oil. The ratio of omega-3 to omega-6 fatty acids in seafood ranges from about 8:1 to 20:1. Oil can be derived from abalone scallops, albacore tuna, anchovies, catfish, clams, cod, gem fish, herring, lake trout, mackerel, menhaden, orange roughy, salmon, sardines, sea mullet, sea perch, shark, shrimp, squid, trout, and tuna.

In yet another embodiment, the oil can be a plant-derived oil. Plant and vegetable oils are rich in omega-6 fatty acids. Some plant-derived oils, such as flaxseed oil, are especially rich in omega-3 fatty acids. Plant or vegetable oils are generally extracted from the seeds of a plant, but can also be extracted from other parts of the plant. Plant or vegetable oils that are commonly used for cooking or flavoring include, but are not limited to, acai oil, almond oil, amaranth oil, apricot seed oil, argan oil, avocado seed oil, babassu oil, ben oil, blackcurrant seed oil, Borneo tallow nut oil, borage seed oil, buffalo gourd oil, canola oil, carob pod oil, cashew oil, castor oil, coconut oil, coriander seed oil, corn oil, cottonseed oil, evening primrose oil, false flax oil, flax seed oil, grapeseed oil, hazelnut oil, hemp seed oil, kapok seed oil, lallemantia oil, linseed oil, macadamia oil, meadowfoam seed oil, mustard seed oil, okra seed oil, olive oil, palm oil, palm kernel oil, peanut oil, pecan oil, pequi oil, perilla seed oil, pine nut oil, pistachio oil, poppy seed oil, prune kernel oil, pumpkin seed oil, quinoa oil, ramtil oil, rice bran oil, safflower oil, sesame oil, soybean oil, sunflower oil, tea oil, thistle oil, walnut oil, or wheat germ oil. The plant derived oil can also be hydrogenated or partially hydrogenated.

In other embodiments, the oil can be an algae-derived oil. Suitable species of algae, from which oil is extracted, include Bacilliarophy sp., Botryococcus braunii, Chlorophyceae sp., Dunaliella tertiolecta, Euglena gracilis, Isochrysis galbana, Nannochloropsis salina, Nannochloris sp., Neochloris oleoabundans, Phaeodactylum tricornutum, Pleurochrysis carterae, Prymnesium parvum, Scenedesmus dimorphus, Spirulina sp., and Tetraselmis chui.

In alternate embodiments, the oil can be a spice oil or fragrance oil. Suitable examples of spice or fragrant oils include angelica oil, anise oil, basil oil, bergamont oil, orange oil, black pepper oil, calamus oil, citronella oil, calendula oil, camphor oil, cardamom oil, celery oil, chamomile oil, cinnamon oil, clove oil, coriander oil, lemon grass oil, cypress oil, cumin seed oil, davana oil, dill seed oil, eucalyptus oil, fennel seed oil, garlic oil, geranium oil, ginger oil, grape seed oil, hyssop oil, jasmine oil, juniper berry oil, lavender oil, lemon oil, lime oil, myrrh oil, neroli oil, neem oil, nutmeg oil, palm Rosa oil, parsley oil, peppermint oil, rose oil, rosemary oil, rose wood oil, sage oil, sesame oil, spearmint oil, tarragon oil, tea tree oil, thyme oil, tangerine oil, turmeric root oil, vetiver oil, wormwood oil, or yara yara oil.

In various other embodiments, the oil can be a pharmaceutical formulation comprising an oxidatively unstable pharmaceutical, such as arachadonic acid or prostaglandin. The formulation can also comprise an unstable oil as a carrier. Suitable examples of pharmaceutical grade carrier oils include cod liver oil, corn oil, cottonseed oil, eucalyptus oil, lavender oil, olive oil, peanut oil, peppermint oil, safflower oil, sesame oil, and soybean oil. The oil can also be a formulation comprising a fat-soluble vitamin, such as vitamin A, D, K, or E.

The oil can be a preparation of fish materials or fish meal, which is the solid material that remains after most of the water and oil have been removed from the starting fish material. Exemplary fish or marine organisms that can be used in fish meal include anchovy, blue whiting, capelin, crab, herring, mackerel, menhaden, pollack, salmon, shrimp, squid, tuna, and whitefish.

In certain embodiments, the oil can be an animal-derived fat. Non-limiting examples of suitable animal-derived fats include poultry fat, beef tallow, mutton tallow, butter, pork lard, whale blubber, and yellow grease (which may be a mixture of vegetable and animal fats).

In various preferred embodiments, the oil is a fish oil comprising at least 10% by weight of omega-3 fatty acids, and more preferably, at least 20% by weight of omega-3 fatty acids.

Fish Oil Emulsions

In various preferred embodiments, the oil having at least 10 wt. % of the at least one omega-3 fatty acid is added to the extrusion feed mixture as an emulsion. Typically, the emulsion comprises an oil described above, water, one or more emulsifiers, a bulking agent, and a phospholipid.

The fish oil emulsion can comprise at least one emulsifier. These emulsifiers can be a protein, gum arabic, or combinations thereof. The protein can be a vegetable protein, an animal protein, a fungal protein, a microbial protein, or a mixture thereof. Non-limiting examples of an animal protein suitable for use in this invention include casein, dairy whey protein, gelatin, or a mixture thereof. Non-limiting examples of a vegetable protein include soy protein, corn protein, pea protein, wheat protein, or a mixture thereof. The corn protein can be corn gluten meal, or more preferably, zein. The wheat protein can be wheat gluten. A preferred vegetable protein is soy protein. In certain embodiments, the protein is an unhydrolyzed soy protein. The protein is present in the emulsion at a concentration of about 0.1% to about 5% by weight based on the total weight of the emulsion. The protein is present in the emulsion at a concentration of about 1% to about 2% by weight based on the total weight of the emulsion.

The soy protein can be provided by a preparation of soy flour, soy concentrate, or soy isolate. These preparations of soy protein are typically formed from a soybean starting material, which can be soybeans or a soybean derivative. Preferably, the soybean starting material can be soybean cake, soybean chips, soybean meal, soybean flakes, or a mixture of these materials. The soybean cake, chips, meal, or flakes can be formed from soybeans according to conventional procedures in the art. That is, soybean cake and soybean chips are generally formed by extraction of part of the oil from soybeans by pressure or solvents; soybean flakes are generally formed by cracking, heating, and flaking soybeans and reducing the oil content of the soybeans by solvent extraction; and soybean flour is generally formed by grinding soybean cake, chips, or flakes.

When the emulsion contains gum arabic as an emulsifier, it is present at a concentration of about 0.1% to about 10% by weight based on the total weight of the emulsion. In certain embodiments, the gum arabic is present in the emulsion at a concentration of about 3% to about 7% by weight based on the total weight of the emulsion.

The emulsion can also contain a bulking agent such as hydrolyzed pork gelatin. The bulking agent is present in the emulsion at a concentration from about 5% to about 15% by weight based on the total weight of the emulsion. In certain embodiments, the bulking agent is present in the emulsion at a concentration from about 8% to about 12% by weight based on the total weight of the emulsion.

The emulsion can further comprise a phospholipid to stabilize the oil and thus, to reduce its oxidation. A phospholipid comprises a backbone, a negatively charged phosphate group, a nitrogen-containing alcohol, and two fatty acids. Phospholipids having a glycerol backbone are termed glycerophospholipids, and include phosphatidylcholine, phosphatidylethanolamine, phosphatidylinositol, phosphatidylserine, phosphatidic acid, and diphosphatidylglycerol. Phospholipids having a sphingosine backbone are called sphingomyelins. The fatty acids attached via ester bonds to the backbone of a phospholipid tend to be 12 to 20 carbons in length, and some can be unsaturated. For example, phospholipids can contain oleic acid (18:1), linoleic acid (18:2, an omega-6), and linolenic:acid (18:3, an omega-3). The two fatty acids of a phospholipid can be the same or they can be different; e.g., dipalmitoylphosphatidylcholine, 1-stearyoyl-2-myristoylphosphatidylcholine, or 1-palmitoyl-2-linoleoylethanolamine.

In various embodiments, the phospholipid can be a single purified phospholipid, such as distearoylphosphatidylcholine. In another embodiment, the phospholipid can be mixture of purified phospholipids, such as a mix of phosphatidylcholines. In still another embodiment, the phospholipid can be a mixture of different types of purified phospholipids, such as a mix of phosphatidylcholines and phosphatidylinositols or a mixture of phosphatidylcholines and phosphatidylethanolamines.

In alternate embodiments, the phospholipid can be a complex mix of phospholipids provided by lecithin. Lecithin is found in nearly every living organism. Commercial sources of lecithin include soybeans, rice, sunflower seeds, chicken egg yolks, milk fat, bovine brain, bovine heart, and algae. In its crude form, lecithin is a complex mixture of phospholipids, glycolipids, triglycerides, sterols and small quantities of fatty acids, carbohydrates and sphingolipids. Soy lecithin is rich in phosphatidylcholine, phosphatidylethanolamine, phosphatidylinositol, and phosphatidic acid. Lecithin can be de-oiled and treated such that it is an essentially pure mixture of phospholipids. Lecithin can be modified to make the phospholipids more water-soluble. Modifications include hydroxylation, acetylation, and enzyme treatment, in which one of the fatty acids is removed by a phospholipase enzyme and replaced with a hydroxyl group.

The phospholipid can be a soy lecithin produced under the trade name Solec by Solae, LLC (St. Louis, Mo.). The soy lecithin can be Solec®F (a dry, de-oiled, non enzyme modified preparation containing about 97% phospholipids), Solec®8160 (a dry, de-oiled, enzyme modified preparation containing about 97% phospholipids), Solec®8120 (a dry, de-oiled, hydroxylated preparation containing about 97% phospholipids), Solec®8140 (a dry, de-oiled, heat resistant preparation containing about 97% phospholipids), or Solec®R(a dry, de-oiled preparation in granular form containing about 97% phospholipids). All of the aforementioned lecithin preparations have hydrophile/lipophile balance (HLB) ratios equal to or greater than 7, indicating that they are readily dispersible in water or aqueous solutions.

The ratio of the phospholipid to the oil can and will vary depending upon the nature of the oil and the phospholipid preparation. In particular, the concentration of phospholipid will be of a sufficient amount to minimize or prevent the oxidation of the oil. In certain preferred embodiments, the concentration of the phospholipid can range from about 0.1% to about 5% by weight based on the total weight of the emulsion; preferably, the concentration of the phospholipid can be about 0.5% to about 2% by weight based on the total weight of the emulsion.

In various preferred embodiments, the oil emulsion comprises fish oil, water, an unhydrolyzed soy protein, gum arabic, hydrolyzed pork gelatin, and soy lecithin.

The emulsion is preferably an oil-in-water emulsion. Without being bound by theory, it is hypothesized that the oil emulsion forms a droplet of oil with a protective emulsion coating that is then incorporated into the extrudate intact and imparts stability to the oil that is not observed when neat oil is added to the extrusion feed mixture.

In various preferred embodiments, the oil emulsion also contains a stabilizing agent. This stabilizing agent is typically an antioxidant such as ascorbic acid and its salts, ascorbyl palmitate, ascorbyl stearate, anoxomer, N-acetylcysteine, benzyl isothiocyanate, o-, m- or p-amino benzoic acid, butylated hydroxyanisole (BHA), butylated hydroxytoluene (BHT), caffeic acid, canthaxantin, alpha-carotene, beta-carotene, beta-caraotene, beta-apo-carotenoic acid, camosol, carvacrol, catechins, cetyl gallate, chlorogenic acid, citric acid and its salts, clove extract, coffee bean extract, p-coumaric acid, 3,4-dihydroxybenzoic acid, N,N′-diphenyl-p-phenylenediamine (DPPD), dilauryl thiodipropionate, distearyl thiodipropionate, 2,6-di-tert-butylphenol, dodecyl gallate, edetic acid, ellagic acid, erythorbic acid, sodium erythorbate, esculetin, esculin, 6-ethoxy-1,2-dihydro-2,2,4-trimethylquinoline, ethyl gallate, ethyl maltol, ethylenediaminetetraacetic acid (EDTA), eucalyptus extract, eugenol, ferulic acid, flavonoids, flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, N-hydroxysuccinic acid, hydroxytryrosol, hydroxyurea, ice bran extract, lactic acid and its salts, lecithin, lecithin citrate; R-alpha-lipoic acid, lutein, lycopene, malic acid, maltol, 5-methoxy tryptamine, methyl gallate, monoglyceride citrate, monoisopropyl citrate, morin, beta-naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, pimento extract, propyl gallate, polyphosphates, quercetin, trans-resveratrol, rosemary extract, rosmarinic acid, sage extract, sesamol, silymarin, sinapic acid, succinic acid, stearyl citrate, syringic acid, tartaric acid, thymol, tocopherols (i.e., alpha-, beta-, gamma- and delta-tocopherol), tocotrienols (i.e., alpha-, beta-, gamma- and delta-tocotrienols), tyrosol, vanilic acid, 2,6-di-tert-butyl-4-hydroxymethylphenol (i.e., Ionox 100), 2,4-(tris-3′,5′-bi-tert-butyl-4′-hydroxybenzyl)-mesitylene (i.e., Ionox 330), 2,4,5-trihydroxybutyrophenone, ubiquinone, tertiary butyl hydroquinone (TBHQ), thiodipropionic acid, trihydroxy butyrophenone, tryptamine, tyramine, uric acid, vitamin K and derivatives, vitamin Q10, wheat germ oil, zeaxanthin, or combinations thereof. Preferred antioxidants include tocopherols, ascorbyl palmitate, rosemary extract, or combinations thereof. The concentration of the additional antioxidant or combination of antioxidants can range from about 0.001% to about 5% by weight. In various preferred embodiments, the concentration of the additional antioxidant or combination of antioxidants can range from about 0.01% to about 1% by weight.

### Protein

The protein-containing feed mixture comprises at least one source of protein and has an overall protein concentration of at least about 20%, 30%, 40%, 50%, 60%, 70%, 80%, 90%, or more protein by weight on a moisture-free basis. In various preferred embodiments, the protein concentration in the feed mixture is at least about 50%, 60%, 70%, 80%, 90%, or more protein by weight on a moisture-free basis. Proteins contained in the feed mixture can be obtained from one or more suitable sources including, for example, vegetable protein materials. Vegetable protein materials can be obtained from cereal grains such as wheat, corn, and barley, and vegetables such as legumes, including soybeans and peas. In preferred embodiments, a soy protein material is the source of the protein.

Typically, when soy protein is present in the protein extrudates, the soy protein is present in an amount of from about 50% to about 99% by weight on a moisture-free basis based on the weight of the protein extrudate. In some instances, the soy protein is present in the protein extrudate in an amount of from about 50% to about 90% by weight on a moisture-free basis and, in other instances, from about 55% to about 75% by weight on a moisture-free basis.

Suitable soy protein materials include soy flakes, soy flour, soy grits, soy meal, soy protein concentrates, soy protein isolates, and mixtures thereof. The primary difference between these soy protein materials is the degree of refinement relative to whole soybeans. Soy flour generally has a particle size of less than about 150 μm. Soy grits generally have a particle size of about 150 μm to about 1000 μm. Soy meal generally has a particle size of greater than about 1000 μm. Soy protein concentrates typically contain about 65 wt. % to less than 90 wt. % soy protein. Soy protein isolates, more highly refined soy protein materials, are processed to contain at least 90 wt. % soy protein and little or no soluble carbohydrates or fiber.

The overall protein content of the feed mixture can be achieved by a combination (i.e., blend) of suitable sources of protein described above. In certain embodiments, when soy protein is used, it is preferred for soy protein isolates to constitute one or more of the sources of protein contained in the feed mixture. For example, a preferred feed mixture formulation can comprise a blend of two or more soy protein isolates. Other suitable formulations can comprise a soy protein concentrate in combination with a soy protein isolate.

Generally, the bulk density of the source of soy protein, other protein source, or blend of sources is from about 0.20 g/cm³ to about 0.50 g/cm³ and, more typically, from about 0.24 g/cm³ to about 0.44 g/cm³.

Blends of Hydrolyzed and Unhydrolyzed Proteins

In certain embodiments in which the feed mixture comprises a plurality of soy protein materials, it is desired that at least one of the soy protein materials exhibits low viscosity and low gelling properties. The viscosity and/or gelling properties of an isolated soy protein may be modified by a wide variety of methods known in the art. For example, the viscosity and/or gelling properties of a soy protein isolate may be decreased by partial hydrolysis of the protein with an enzyme which partially denatures the protein materials. Typically, soy protein materials treated in this manner are described in terms of degree of hydrolysis which can be determined based on molecular weight distributions, sizes of proteins and chain lengths, or breaking down of beta-conglycinin or glycinin storage proteins. As used herein, the term “percent degree of hydrolysis” of a sample is defined as the percentage of cleaved peptide bonds out of the total number of peptide bonds in the sample. The proportion of cleaved peptide bonds in a sample can be measured by calculating the amount of trinitrobenzene sulfonic acid (TNBS) that reacts with primary amines in the sample under controlled conditions.

Hydrolyzed protein materials used in accordance with the process of the present invention typically exhibit TNBS values of less than about 160, more typically less than about 115 and, still more typically, from about 30 to about 70.

Hydrolyzed soy protein sources sufficient for use as a low viscosity/low gelling material in the process of the present invention typically have a degree of hydrolysis of less than about 15%, preferably less than about 10% and, more preferably, from about 1% to about 5%. In the case of soy protein isolates, the hydrolyzed soy protein material typically comprises a partially hydrolyzed soy protein isolate having a degree of hydrolysis of from about 1% to about 5%.

In accordance with some embodiments of the present invention, a low viscosity/low gelling source is preferably combined with a high viscosity/high gelling source to form the blend. The presence of the high viscosity/high gelling source reduces the risk of excessive expansion of the blend upon extrusion, provides a honeycomb structure to the extrudate, and generally contributes stability to the blend. The low viscosity/low gelling and high viscosity/high gelling sources can be combined in varying proportions depending on the desired characteristics of the extrudate.

In certain embodiments, the protein-containing feed mixture typically comprises a blend of soy protein isolates comprising at least about 1.5 parts by weight of a hydrolyzed (i.e., generally low viscosity/low gelling) soy protein isolate per part by weight of an unhydrolyzed (i.e., generally high viscosity/high gelling) soy protein isolate, in other embodiments, at least about 3 parts by weight of a hydrolyzed soy protein isolate per part by weight of an unhydrolyzed soy protein isolate and, in still other embodiments, at least about 4 parts by weight of a hydrolyzed soy protein isolate per part by weight of an unhydrolyzed soy protein isolate. Preferably, the blend of soy protein isolates comprises from about 1.5 parts by weight to about 6 parts by weight of a hydrolyzed soy protein isolate per part by weight of an unhydrolyzed soy protein isolate. More preferably, the blend of soy protein isolates comprises from about 2 parts by weight to about 4 parts by weight of a hydrolyzed soy protein isolate per part by weight of an unhydrolyzed soy protein isolate.

In various preferred embodiments, the protein extrudate also comprises the same ratios of hydrolyzed:unhydrolyzed soy protein as described for the feed mixture.

Blends comprising a plurality of soy protein isolates typically comprise from about 40% to about 80% by weight of a hydrolyzed soy protein isolate on a moisture-free basis and from about 0% to about 40% by weight of an unhydrolyzed soy protein isolate on a moisture-free basis, based on the weight of the feed mixture or protein extrudate. More typically, such blends comprise from about 50% to about 70% by weight of a hydrolyzed soy protein isolate on a moisture-free basis and from about 10% to about 30% by weight of an unhydrolyzed soy protein isolate on a moisture-free basis. More typically, such blends comprise from about 50% to about 60% by weight of a hydrolyzed soy protein isolate on a moisture-free basis and from about 20% to about 30% by weight of an unhydrolyzed soy protein isolate on a moisture-free basis.

Suitable isolated soy protein sources for use as a low viscosity/low gelling (i.e., partially hydrolyzed) soy protein material include SUPRO® 219, SUPRO® 312, SUPRO® 313, SUPRO® 670, SUPRO® 710, SUPRO® 8000, and Soless® H102 available from Solae, LLC (St. Louis, Mo.), and PROFAM 931 and PROFAM 873 available from Archer Daniels Midland (Decatur, Ill.). For SUPRO® 670, SUPRO® 710, and SUPRO® 8000, the degree of hydrolysis can range from about 0.5%-5.0%. The molecular weight distribution of each of these isolates can be determined by size exclusion chromatography.

Suitable sources of high viscosity and/or medium/high gelling isolated soy protein (i.e., unhydrolyzed) for use as the second soy protein isolate include SUPRO® 248, SUPRO® 620, SUPRO® 500E, SUPRO® 630, SUPRO® 1500, SUPRO® EX33, SUPRO® EX45, ISP-95, Soy Quick® ISP 90, Soless® G101, Fuji Pro® Deluxe White-ISP available from Solae, LLC (St. Louis, Mo.); PROFAM 981 available from Archer Daniels Midland (Decatur, Ill.); and Solae soy protein isolate available from Solae, LLC (St. Louis, Mo.).

Table 1 provides molecular weight distributions for certain of the commercial SUPRO® products mentioned above.

TABLE 1
Average Molecular Weight of Solae soy protein products determined
using HPLC-SEC (High Performance Liquid Chromatography -
Size Exclusion Chromatography) gel filtration in 6M guanidine HCl.

| | | | Average |
|---|---|---|---|
| Hydrolyzed | Average Mol. Wt. | Unhydrolyzed | Mol. Wt. |
| Soy Protein | (SEC [kD]) | Soy Protein | (SEC [kD]) |
| SUPRO ® 313 | 8000-12000 | SUPRO ® 620 | 30000-35000 |
| SUPRO ® 710 | 12000-14000 | SUPRO ® 248 | 30000-35000 |
| SUPRO ® 219 | 12000-14000 | SUPRO ® 1500 | 30000-35000 |
| SUPRO ® 312 | 14000-18000 | ISP-95 | 30000-35000 |
| SUPRO ® 8000 | 14000-18000 | SUPRO ® EX 45 | 30000-35000 |
| SOLESS H102 | 14000-18000 | Soy Quick ISP 90 | 30000-35000 |
| SUPRO ® 670 | 19000-25000 | SOLESS G101 | 30000-38000 |
| | | FPDW-ISP | 30000-38000 |

### Expansion Aids

Modified starches such as cross-linked corn, wheat and/or rice starches, native and modified pregelatinized starches such as corn, wheat, potato, tapioca, rice. Pregelatinized flours such as corn, wheat, rice PAC-GEL 45, PAC-GEL 70 or PAC-GEL 120 Pregelatinized rice flour (Pacific Grain Products Woodland, Calif.), Fibrim (FIBRIM® brand soy fiber is an 80 percent total dietary fiber ingredient available from Solae, LLC, dicalcium phosphate, and soy lecithin powder can be added to control expansion of the protein extrudate, modify the cell structure in final products, and help improve the flowability of the feed mixture in the process.

### Carbohydrates

The protein-containing feed mixture may also contain one or more carbohydrate sources in an amount of from about 0.001% to about 30% by weight carbohydrates on a moisture-free basis. The carbohydrates present in the feed mixture can be soluble carbohydrates or insoluble carbohydrates. Typically, the protein-containing feed mixture comprises about 10% to about 25% by weight carbohydrates on a moisture-free basis and, more typically from about 18% to about 22% by weight carbohydrates on a moisture-free basis. In some embodiments, the extrudate contains from about 10% to about 20% by weight carbohydrates. In other instances, from about 1 to about 5 wt. % or from about 1 to about 10 wt. % carbohydrates are in the feed mixture or protein extrudate. Suitable sources of soluble carbohydrates include, for example, cereals, tubers and roots such as rice (e.g., rice flour), wheat, corn, barley, potatoes (e.g., native potato starch), and tapioca (e.g., native tapioca starch). Insoluble carbohydrates such as fiber do not contribute to nutritive carbohydrate load yet aid in processing of the mixture by facilitating flowability and expansion of the feed mixture. Generally, the feed mixture comprises from about 0.001% to about 5% by weight fiber and, more generally, from about 1% to about 3% by weight fiber. Soy fiber absorbs moisture as the extrusion mass flows through the extrusion barrel to the die. A modest concentration of soy fiber is believed to be effective in reducing cross-linking of protein molecules, thus preventing excessive gel strength from developing in the cooked extrusion mass exiting the die. Unlike the protein, which also absorbs moisture, soy fiber readily releases moisture upon release of pressure at the die exit temperature. Flashing of the moisture released contributes to expansion, i.e., “puffing,” of the extrudate, and producing the low density extrudate of the invention. Typically, the extrudates also contain from about 0.001% to about 5% by weight fiber on a moisture free basis and, more typically, from about 1% to about 3% by weight fiber on a moisture free basis.

### Water

Generally, water is present in the dried extrudate at a concentration of from about 1 to about 7 wt. %, or from about 2% to about 5.5 wt. %. The amount of water may vary depending on the desired composition and physical properties of the extrudate (e.g., carbohydrate content and density).

### Physical Properties

Generally, the protein extrudates of the present invention have a density of from about 0.02 g/cm³ to about 0.5 g/cm³. Preferably, the protein extrudates of the present invention have a density of from about 0.1 to about 0.4 g/cm³ or from about 0.15 g/cm³ to about 0.35 g/cm³. In such embodiments, the density of the extrudate may be from about 0.20 g/cm³ to about 0.27 g/cm³, from about 0.24 g/cm³ to about 0.27 g/cm³, or from about 0.27 g/cm³ to about 0.32 g/cm³. In other instances, the protein extrudate is a puff having a density of from about 0.02 to about 0.1 g/cm³ or from about 0.02 to about 0.05 g/cm³.

In various embodiments, soy protein isolate and native tapioca starch are used to help create expansion in the extrudates and obtain the desired product density. These ingredients release the water trapped during the extrusion cooking process; the shrinkage ratio when the water is released in the form of steam is minimized when soy protein isolate and native tapioca starch are in the formula, forming larger cells in the product structure. Because of the larger size of the cells, the concentration of cells in the product decreases and the air space in the product increases, thus affecting the texture and resulting in a lower density product.

The protein extrudates of the present invention may further be characterized as having a hardness of at least about 1000 grams. Typically, the protein extrudates have a hardness of from about 1000 grams to about 50,000 grams and, more typically, from about 5,000 grams to about 40,000 grams. In various preferred embodiments, the hardness is from about 7,000 grams to about 30,000 grams. The hardness of the extrudates is generally determined by placing an extrudate sample in a container and crushing the sample with a probe. The force required to break the sample is recorded; the force that is required to crush the sample based on its size or weight is proportional to the hardness of the product. The hardness of the extrudates may be determined using a TA.TXT2 Texture Analyzer having a 25 kg load cell, manufactured by Stable Micro Systems Ltd. (England).

Further the protein extrudates have a crispiness value of about 5-9. The crispiness of the extrudates may be determined using a TA.TXT2 Texture Analyzer having a 25 kg load cell, manufactured by Stable Micro Systems Ltd. (England). The products can also have a wide range of pellet durability index (PDI) values usually on the order of from about 65-99, more preferably from about 80-97.

### Particle Sizes

The protein extrudates may exhibit a wide range of particle sizes and may generally be characterized as an oval or round nugget or pellet. The following weight percents for characterizing the particle sizes of the extrudates of the present invention are provided on an “as is” (i.e., moisture-containing) basis.

In certain embodiments, the particle size of the extrudate is such that from about 0.5% to about 15% by weight of the particles are retained on a 4 Mesh Standard U.S. sieve, from about 80% to about 95% by weight of the particles are retained on an 6 Mesh Standard U.S. sieve, from about 0% to about 2% by weight are retained on a 8 Mesh Standard U.S. sieve.

Such extrudates can have a length of from about 3 to about 7 mm and, more typically, about 5 mm, along with a width of from about 0.5 to about 3.5 mm and, more typically, about 2 mm. Extrudate nuggets having these characteristics may be shredded to produce a textured soy protein product.

The extrudate nuggets described above can also be ground to produce a powdered soy protein product. Such powder typically has a particle size appropriate to the particular application. In certain embodiments, the powder has an average particle size of less than about 10 μm. More typically, the average particle size of the ground extrudate is less than about 5 μm and, still more typically, from about 1 to about 3 μm.

### Color

The color intensity of the protein extrudate can be adjusted using cocoa powder, caramel, and mixtures thereof. Increasing the amount of cocoa powder and/or caramel yields darker, more intensely colored extrudates. Cocoa is added to the protein-containing feed mixture in the form of cocoa powder. Typically, the protein-containing feed mixture comprises from about 1% to about 8% by weight cocoa powder based on the total weight of the feed mixture on a moisture-free basis. Suitable cocoa powder sources are Cocoa Powder from Bloomer Chocolate (Chicago, Ill.) and ADM Cocoa, Archer Daniels Midland (Decatur, Ill.).

In various embodiments, the color L value of the protein extrudate is greater than 50. In some of these various embodiments, the color A value of the protein extrudate is 2.5 to 4. In other various embodiments, the color B value of the protein extrudate is 17 to 20. Alternatively, in other embodiments, the color L value of the protein extrudate is less than 35.

### Food Products

The extrudates of the present invention are suitable for incorporation into a variety of food products including, for example, food bars and ready to eat cereals. Such extrudates may generally be oval or round and may also be shredded. Powdered extrudates are suitable for incorporation into a variety of food products including, for example, beverages, dairy products (e.g., soy milk and yogurt), baked products, meat products, soups, and gravies. The protein extrudates can be incorporated in such applications in the form of nuggets or pellets, shredded nuggets or pellets, or powders as described above. A particle size of less than about 5 μm is particularly desirable in the case of extrudates incorporated into beverages to prevent a “gritty” taste in the product.

In some embodiments, the protein extrudate is in the form of a low density snack product. Typically, such products include between about 25% and about 95% by weight protein. These low density snack food products generally have a density of from about 0.02 g/cm³ to about 0.7 g/cm³ and, more generally, from about 0.02 g/cm³ to about 0.5 g/cm³. Generally, such extrudates exhibit a crisp, non-fibrous eating texture. In certain embodiments, the products have a density of from about 0.1 g/cm³ to about 0.4 g/cm³, from about 0.15 g/cm³ to about 0.35 g/cm³, from about 0.20 g/cm³ to about 0.27 g/cm³, from about 0.24 g/cm³ to about 0.27 g/cm³, or alternatively from about 0.27 g/cm³ to about 0.32 g/cm³. In other instances, the products have a density of from about 0.02 to about 0.1 g/cm³ or from about 0.02 to about 0.05 g/cm³.

In addition to protein, the food products of the present invention may comprise other solid components (i.e., fillers) such as carbohydrates or fibers. The product may include filler in a ratio of filler to protein in the range of from about 5:95 to about 75:25. In certain embodiments, a majority of the filler is starch. Suitable starches include rice flour, potato, tapioca, and mixtures thereof.

Low density food products of the present invention typically contain water at a concentration of between about 1% and about 7% by weight of protein, filler, and water and, more typically, between about 3% and about 5% by weight of protein, filler, and water.

### Meats

In various embodiments, the protein extrudate of the present invention is used in emulsified meats to provide structure to the emulsified meat, providing a firm bite and a meaty texture. The protein extrudate also decreases cooking loss of moisture from the emulsified meat by readily absorbing water, and prevents “fatting out” of the fat in the meat so the cooked meat is juicier.

The meat material used to form a meat emulsion in combination with the protein extrudate of the present invention is preferably a meat useful for forming sausages, frankfurters, or other meat products which are formed by filling a casing with a meat material, or can be a meat which is useful in ground meat applications such as hamburgers, meat loaf and minced meat products. Particularly preferred meat material used in combination with the protein extrudate includes mechanically deboned meat from chicken, beef, and pork; pork trimmings; beef trimmings; and pork backfat.

Typically, the ground protein extrudate is present in the meat emulsion in an amount of from about 0% to about 4% by weight, more typically from about 0% to about 3% by weight and, still more typically, from about 1% to about 3% by weight.

Typically, the meat material is present in the meat emulsion in an amount of from about 40% to about 95% by weight, more typically from about 50% to about 90% by weight and, still more typically, from about 60% to about 85% by weight.

The meat emulsion also contains water, which is typically present in an amount of from about 0% to about 25% by weight, more typically from about 0% to about 20% by weight, even more typically from about 0% to about 15% by weight and, still more typically, from about 0% to about 10% by weight.

The meat emulsion may also contain other ingredients that provide preservative, flavoring, or coloration qualities to the meat emulsion. For example, the meat emulsion may contain salt, typically from about 1% to about 4% by weight; spices, typically from about 0.1% to about 3% by weight; and preservatives such as nitrates, typically from about 0.001% to about 0.5% by weight.

### Beverages

The protein extrudate of the present invention may be used in beverage applications including, for example, acidic beverages. Typically, the ground protein extrudate is present in the beverage in an amount of from about 0.5% to about 3.5% by weight. The beverages in which the protein extrudate is incorporated typically contain from about 70% to about 90% by weight water, and may contain sugars (e.g., fructose and sucrose) in an amount of up to about 20% by weight.

### Extrusion Process

Extrusion cooking devices have long been used in the manufacture of a wide variety of edible and other products such as human and animal feeds. Generally speaking, these types of extruders include an elongated barrel together with one or more internal, helically flighted, axially rotatable extrusion screws therein. The outlet of the extruder barrel is equipped with an aperture extrusion die. In use, a material to be processed is passed into and through the extruder barrel and is subjected to increasing levels of temperature, pressure and shear. As the material emerges from the extruder die, it is fully cooked and shaped and may typically be subdivided using a rotating knife assembly. Conventional extruders of this type are described, for example, in U.S. Pat. Nos. 4,763,569, 4,118,164 and 3,117,006, which are incorporated herein by reference. Alternatively, the texturized protein product may be cut into smaller extrudates such as “nuggets” or powders for use as food ingredients.

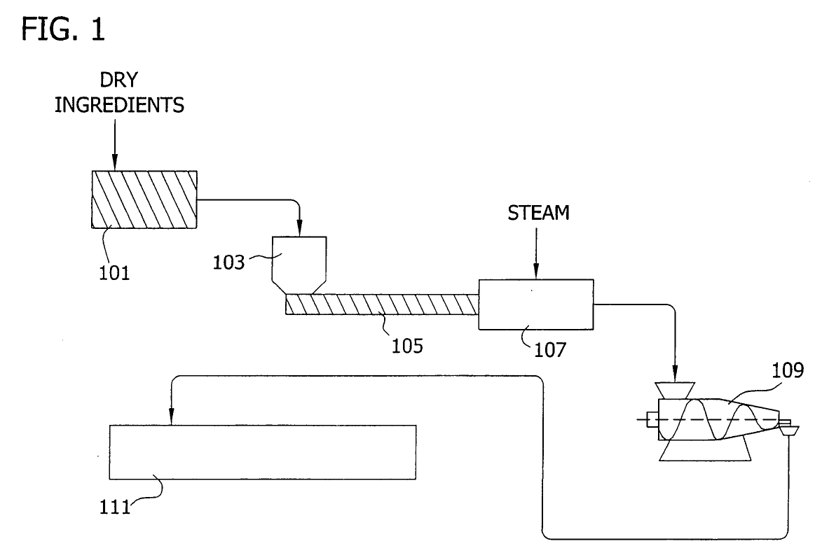

Referring now to FIG. 1, one embodiment of the process of the present invention is shown. The process comprises introducing the particular ingredients of the protein-containing feed mixture formulation into a mixing tank 101 (i.e., an ingredient blender) to combine the ingredients and form a protein feed pre-mix. The pre-mix is then transferred to a hopper 103 where the pre-mix is held for feeding via screw feeder 105 to a pre-conditioner 107 to form a conditioned feed mixture. The conditioned feed mixture is then fed to an extrusion apparatus (i.e., extruder) 109 in which the feed mixture is heated under mechanical pressure generated by the screws of the extruder to form a molten extrusion mass. The molten extrusion mass exits the extruder through an extrusion die.

In pre-conditioner 107, the particulate solid ingredient mix (i.e., protein feed pre-mix) is preheated, contacted with moisture, and held under controlled temperature and pressure conditions to allow the moisture to penetrate and soften the individual particles. The pre-conditioning step increases the bulk density of the particulate feed mixture and improves its flow characteristics. The pre-conditioner 107 contains one or more paddles to promote uniform mixing of the feed mixture and transfer of the feed mixture through the pre-conditioner. The configuration and rotational speed of the paddles vary widely, depending on the capacity of the pre-conditioner, the extruder throughput and/or the desired residence time of the feed mixture in the pre-conditioner or extruder barrel. Generally, the speed of the paddles is from about 500 to about 1300 revolutions per minute (rpm).

Typically, the protein-containing feed mixture is pre-conditioned prior to introduction into the extrusion apparatus 109 by contacting a pre-mix with moisture (i.e., steam and/or water) at a temperature of at least about 45° C. (110° F.). More typically, the feed mixture is conditioned prior to heating by contacting a pre-mix with moisture at a temperature of from about 45° C. (110° F.) to about 85° C. (185° F.). Still more typically, the feed mixture is conditioned prior to heating by contacting a pre-mix with moisture at a temperature of from about 45° C. (110° F.) to about 70° C. (160° F.). It has been observed that higher temperatures in the pre-conditioner may encourage starches to gelatinize, which in turn may cause lumps to form which may impede flow of the feed mixture from the pre-conditioner to the extruder barrel.

Typically, the pre-mix is conditioned for a period of about 1 to about 6 minutes, depending on the speed and the size of the conditioner. More typically, the pre-mix is conditioned for a period of from about 2 minutes to about 5 minutes, most typically about 3 minutes. The pre-mix is contacted with steam and/or water and heated in the pre-conditioner 107 at generally constant steam flow to achieve the desired temperatures. The water and/or steam conditions (i.e., hydrates) the feed mixture, increases its density, and facilitates the flowability of the dried mix without interference prior to introduction to the extruder barrel where the proteins are texturized. In certain embodiments, the feed mixture pre-mix is contacted with both water and steam to produce a conditioned feed mixture. For example, experience to date suggests that it may be preferable to add both water and steam to increase the density of the dry mix as steam contains moisture to hydrate the dry mix and also provides heat which promotes hydration of the dry mix by the water.

The conditioned pre-mix may contain from about 5% to about 25% by weight water. Preferably, the conditioned pre-mix contains from about 5% to about 15% by weight water. The conditioned pre-mix typically has a bulk density of from about 0.25 g/cm³ to about 0.6 g/cm³. Generally, as the bulk density of the pre-conditioned feed mixture increases within this range, the feed mixture is easier to convey and further to process. This is presently believed to be due to such mixtures occupying all or a majority of the space between the screws of the extruder, thereby facilitating conveying the extrusion mass through the barrel.

The conditioned pre-mix is generally introduced to the extrusion apparatus 109 at a rate of about 10 kilograms (kg)/min (20 lbs/min). In some of the various embodiments, the conditioned pre-mix is introduced to the barrel at a rate of from about 2 to about 10 kg/min (from about 5 to about 20 lbs/min), more typically from about 5 to about 10 kg/min (from about 10 to about 20 lbs/min) and, still more typically, from about 6 to about 8 kg/min (from about 12 to about 18 lbs/min). Generally, it has been observed that the density of the extrudate decreases as the feed rate of pre-mix to the extruder increases. The residence time of the extrusion mass in the extruder barrel is typically less than about 60 seconds, more typically less than about 30 seconds and, still more typically, from about 15 seconds to about 30 seconds.

Typically, extrusion mass passes through the barrel at a rate of from about 7.5 kg/min to about 40 kg/min (from about 17 lbs/min to about 85 lbs/min). More typically, extrusion mass passes through the barrel at a rate of from about 7.5 kg/min to about 30 kg/min (from about 17 lbs/min 65 lbs/min). Still more typically, extrusion mass passes through the barrel at a rate of from about 7.5 kg/min to about 22 kg/min (from about 17 lbs/min to about 50 lbs/min). Even more typically, extrusion mass passes through the barrel at a rate of 7.5 kg/min to about 15 kg/min (from about 17 lbs/min to about 35 lbs/min). Usually the amount of mass going throughout the extruder will be driven by the size and configuration of the extruder.

Various extrusion apparatus suitable for forming a molten extrusion mass from a feed material comprising vegetable protein are well known in the art. One suitable extrusion apparatus is a double-barrel, twin screw extruder as described, for example, in U.S. Pat. No. 4,600,311. Examples of commercially available double-barrel, twin screw extrusion apparatus include a CLEXTRAL Model BC-72 extruder manufactured by Clextral, Inc. (Tampa, Fla.) having an L/D ratio of 13.5:1 and four barrel zones; a WENGER Model TX-57 extruder manufactured by Wenger (Sabetha, Kans.) having an L/D ratio of 14:1 and four barrel zones; and a WENGER Model TX-52 extruder manufactured by Wenger (Sabetha, Kans.) having an L/D ratio of 13.5:1 and four barrel zones. Other suitable extruders include CLEXTRAL Models Evolum 68, BC-82 and BC-92 and WENGER Models TX-138, TX-144, TX-162, and TX-168.

The ratio of the length and diameter of the extruder (L/D ratio) generally determines the length of extruder necessary to process the mixture and affects the residence time of the mixture therein. Generally the L/D ratio is greater than about 10:1, greater than about 15:1, greater than about 20:1, or even greater than about 25:1.

The screws of a twin screw extruder can rotate within the barrel in the same or opposite directions. Rotation of the screws in the same direction is referred to as single flow whereas rotation of the screws in opposite directions is referred to as double flow.

The speed of the screw or screws of the extruder may vary depending on the particular apparatus. However, the screw speed is typically from about 250 to about 400 revolutions per minute (rpm), more typically from about 260 to about 380 rpm and, still more typically, from about 270 to about 370 rpm. Generally, as the screw speed increases, the density of the extrudates decreases.

The extrusion apparatus 109 generally comprises a plurality of barrel zones through which feed mixture is conveyed under mechanical pressure prior to exiting the extrusion apparatus 109 through an extrusion die. The temperature in each successive barrel zone generally exceeds the temperature of the previous heating zone by between about 10° C. and about 70° C. (between about 15° F. and about 125° F.), more generally by between about 10° C. and about 50° C. (from about 15° F. to about 90° F.) and, more generally, from about 10° C. to about 30° C. (from about 15° F. to about 55° F.).

For example, the temperature in the last barrel zone is from about 90° C. to about 150° C. (from about 195° F. to about 300° F.), more typically from about 100° C. to about 150° C. (from about 212° F. to about 300° F.) and, still more typically, from about 100° C. to about 130° C. (from about 210° F. to about 270° F.). The temperature in the next to last barrel zone is, for example, from about 80° C. to about 120° C. (from about 175° C. to about 250° C.) or from about 90° C. to about 110° C. (from about 195° F. to about 230° F.). In some embodiments, the temperature in the barrel zone immediately before the next to last barrel zone is from about 70° C. to about 100° C. (from about 160° F. to about 210° F.) and preferably, from about 80° C. to about 90° C. (from about 175° F. to about 195° F.). Typically, the temperature in the barrel zone separated from the last heating zone by two heating zones is from about 50° C. to about 90° C. (from about 120° F. to about 195° F.) and, more typically, from about 60° C. to about 80° C. (from about 140° F. to about 175° F.).

Typically, the extrusion apparatus comprises at least about three barrel zones and, more typically, at least about four barrel zones. In a preferred embodiment, the conditioned pre-mix is transferred through four barrel zones within the extrusion apparatus, with the feed mixture is heated to a temperature of from about 100° C. to about 150° C. (from about 212° F. to about 302° F.) such that the molten extrusion mass enters the extrusion die at a temperature of from about 100° C. to about 150° C. (from about 212° F. to about 302° F.).

In such an embodiment, the first heating zone is preferably operated at a temperature of from about 50° C. to about 90° C. (from about 120° F. to about 195° F.), the second heating zone is operated at a temperature of from about 70° C. to about 100° C. (from about 160° F. to about 212° F.), the third heating zone is operated at a temperature of from about 80° C. to about 120° C. (from about 175° F. to about 250° F.) and the fourth heating zone is operated at a temperature of from about 90° C. to about 150° C. (from about 195° F. to about 302° F.).

The temperature within the heating zones may be controlled using suitable temperature control systems including, for example, Mokon temperature control systems manufactured by Clextral (Tampa, Fla.) or electric heating. Steam may also be introduced to one or more heating zones via one or more valves in communication with the zones to control the temperature. Another alternative is the use oil Mokon unit heated by electric resistance or steam. Some extruders don't have external heating system; the extruder barrel temperatures can be achieved by the shear generated in the system; higher shear will generate greater temperatures. Extruders not having heating system will have cooling water running in the barrel zones; this is to control the energy and temperatures generated by the extruder shear.

Apparatus used to control the temperature of the barrel zones may be automatically controlled. One such control system includes suitable valves (e.g., solenoid valves) in communication with a programmable logic controller (PLC).

The pressure within the extruder barrel is not narrowly critical. Typically the extrusion mass is subjected to a pressure of at least about 400 psig (about 28 bar) and generally the pressure within the last two heating zones is from about 1000 psig to about 3000 psig (from about 70 bar to about 210 bar). The barrel pressure is dependent on numerous factors including, for example, the extruder screw speed, feed rate of the mixture to the barrel, die flow area, feed rate of water to the barrel, and the viscosity of the molten mass within the barrel.

The heating zones within the barrel may be characterized in terms of the action upon the mixture therein. For example, zones in which the primary purpose is to convey the mixture longitudinally along the barrel, mix, compress the mixture, or provide shearing of the proteins are generally referred to as conveying zones, mixing zones, compression zones, and shearing zones, respectively. It should be understood that more than one action may occur within a zone; for example, there may be “shearing/compression” zones or “mixing/shearing” zones. The action upon the mixture within the various zones is generally determined by various conditions within the zone including, for example, the temperature of the zone and the screw profile within the zone.

The extruder is characterized by its screw profile which is determined, at least in part, by the length to pitch ratio of the various portions of the screw. Length (L) indicates the length of the screw while pitch (P) indicates the distance required for 1 full rotation of a thread of the screw. In the case of a modular screw containing a plurality of screw portions having varying characteristics, L can indicate the length of such a portion and P the distance required for 1 full rotation of a thread of the screw. The intensity of mixing, compression, and/or shearing generally increases as the pitch decreases and, accordingly, L:P increases. L:P ratios for the twin-screws within the various heating zones of one embodiment of the present invention are provided below in Table 2.

TABLE 2

| Zone | L:P | Flow |
|---|---|---|
| Conveying | 200/100 | Double flow |
| Conveying | 200/100 | Double flow |
| Conveying | 150/100 | Double flow |
| Compression | 200/66 | Double flow |
| Compression | 200/66 | Double flow |
| Shearing | 100/50 | Double flow |
| Shearing | 100/40 | Single flow |
| Shearing | 100/30 (reverse) | Single flow |

Water is injected into the extruder barrel to hydrate the feed mixture and promote texturization of the proteins. As an aid in forming the molten extrusion mass the water may act as a plasticizing agent. Water may be introduced to the extruder barrel via one or more injection jets. Typically, the mixture in the barrel contains from about 15% to about 30% by weight water. The rate of introduction of water to any of the barrel zones is generally controlled to promote production of an extrudate having desired characteristics. It has been observed that as the rate of introduction of water to the barrel decreases, the density of the extrudate decreases. Typically, less than about 1 kg of water per kg of protein are introduced to the barrel and, more typically less than about 0.5 kg of water per kg of protein and, still more typically, less than about 0.25 kg of water per kg of protein are introduced to the barrel. Generally, from about 0.1 kg to about 1 kg of water per kg of protein are introduced to the barrel.

Referring again to FIG. 1, the molten extrusion mass in extrusion apparatus 109 is extruded through a die (not shown) to produce an extrudate, which is then dried in dryer 111.

Extrusion conditions are generally such that the product emerging from the extruder barrel typically has moisture content of from about 15% to about 45% by weight wet basis and, more typically, from about 20% to about 40% by weight wet basis. The moisture content is derived from water present in the mixture introduced to the extruder, moisture added during preconditioning and/or any water injected into the extruder barrel during processing.

Upon release of pressure, the molten extrusion mass exits the extruder barrel through the die, superheated water present in the mass flashes off as steam, causing simultaneous expansion (i.e., puffing) of the material. The level of expansion of the extrudate upon exiting of mixture from the extruder in terms of the ratio of the cross-sectional area of extrudate to the cross-sectional area of die openings is generally less than about 15:1, more generally less than about 10:1 and, still more generally, less than about 5:1. Typically, the ratio of the cross-sectional area of extrudate to the cross-sectional area of die openings is from about 2:1 to about 11:1 and, more typically, from about 2:1 to about 10:1. The puffed material will form a shape that is generally driven by the geometry of the die to form extruded ropes.

The extrudate mass/ropes are cut after exiting the die to obtain the proper characteristics in the puffed material. Suitable apparatus for cutting the extrudate include flexible knives manufactured by Wenger (Sabetha, Kans.) and Clextral (Tampa, Fla.).

The dryer 111 used to dry the extrudates generally comprises a plurality of drying zones in which the air temperature may vary. Generally, the temperature of the air within one or more of the zones will be from about 135° C. to about 185° C. (from about 280° F. to about 370° F.). Typically, the temperature of the air within one or more of the zones is from about 140° C. to about 180° C. (from about 290° F. to about 360° F.), more typically from about 155° C. to 170° C. (from about 310° F. to 340° F.) and, still more typically, from about 160° C. to about 165° C. (from about 320° F. to about 330° F.). Typically, the extrudate is present in the dryer for a time sufficient to provide an extrudate having desired moisture content. This desired moisture content may vary widely depending on the intended application of the extrudate and, typically, is from about 2.5% to about 6.0% by weight. Generally, the extrudate is dried for at least about 5 minutes and, more generally, for at least about 10 minutes. Suitable dryers include those manufactured by Wolverine Proctor & Schwartz (Merrimac, Mass.), National Drying Machinery Co. (Philadelphia, Pa.), Wenger (Sabetha, Kans.), Clextral (Tampa, Fla.), and Buehler (Lake Bluff, Ill.).

The extrudates may further be comminuted to reduce the average particle size of the extrudate. Suitable grinding apparatus include hammer mills such as Mikro Hammer Mills manufactured by Hosokawa Micron Ltd. (England).

### Definitions and Methods

Omega-3 fatty acid content. Oils that comprise a substantial amount of omega-3 fatty acids have a concentration of omega-3 fatty acids of at least 10 wt. %, based upon the total weight of fatty acids or derivatives thereof in the oil composition. In various preferred embodiments, the oils that comprise omega-3 fatty acids have a concentration of omega-3 fatty acids of at least 15, 20, 25, 30, 35, 40, 45, 50, 55, 60, or more wt. %, based upon the total weight of fatty acids or derivatives thereof in the oil composition.

TNBS. Trinitrobenzene sulfonic acid (TNBS) reacts under controlled conditions with the primary amines of proteins to produce a chromophore which absorbs light at 420 nm. The intensity of color produced from the TNBS-amine reaction is proportional to the total number of amino terminal groups and therefore is an indicator of the degree of hydrolysis of a sample. Such measurement procedures are described, for example, by Adler-Nissen in J. Agric. Food Chem., Vol. 27(6), p. 1256 (1979).

Degree of Hydrolysis. Percent (%) degree of hydrolysis is determined from the TNBS value using the following equation: % degree of hydrolysis=((TNBSᵥₐₗᵤₑ−24)/885)×100. The value, 24, is the correction for lysyl amino group of a non-hydrolyzed sample and the value, 885, is the moles of amino acid per 100 kg of protein.

Protein Content. The Nitrogen-Ammonia-Protein Modified Kjeldahl Method of A.O.C.S. Methods Bc4-91 (1997), Aa 5-91 (1997), and Ba 4d-90 (1997) can be used to determine the protein content of a soy material sample.

Nitrogen Content. The nitrogen content of the sample is determined according to the formula: Nitrogen (%)=1400.67×[[(Normality of standard acid)×(Volume of standard acid used for sample (ml))]−[(Volume of standard base needed to titrate 1 ml of standard acid minus volume of standard base needed to titrate reagent blank carried through method and distilled into 1 ml standard acid (ml))×(Normality of standard base)]−[(Volume of standard base used for the sample (ml))×(Normality of standard base)]]/(Milligrams of sample). The protein content is 6.25 times the nitrogen content of the sample for soy protein.

Extent of Gelation. Gel strength, expressed in terms of the extent of gelation (G) may be determined by preparing a slurry (commonly 200 grams of a slurry having a 1:5 weight ratio of soy protein source to water) to be placed in an inverted frustoconical container which is placed on its side to determine the amount of the slurry that flows from the container. The container has a capacity of approximately 150 ml (5 ounces), height of 7 cm, top inner diameter of 6 cm, and a bottom inner diameter of 4 cm. The slurry sample of the soy protein source may be formed by cutting or chopping the soy protein source with water in a suitable food cutter including, for example, a Hobart Food Cutter manufactured by Hobart Corporation (Troy, Ohio). The extent of gelation, G, indicates the amount of slurry remaining in the container over a set period of time. Low viscosity/low gelling sources of soy protein suitable for use in accordance with the present invention typically exhibit an extent of gelation, on a basis of 200 grams of sample introduced to the container and taken five minutes after the container is placed on its side, of from about 1 gram to about 80 grams (i.e., from about 1 gram to about 80 grams, 0.5% to about 40%, of the slurry remains in the container five minutes after the container is placed on its side). High viscosity/medium to high gelling sources of soy protein suitable for use in accordance with the present invention typically exhibit an extent of gelation, on the same basis described above, of from about 45 grams to about 140 grams (i.e., from about 45 grams to about 140 grams, 22% to about 70%, of the slurry remains in the container five minutes after the container is placed on its side). A blend of sources comprising a low viscosity/low gelling source and a high viscosity/high gelling source typically have a gelation rate, on the same basis, of from about 20 grams to about 120 grams.

Color Value. Color intensity of the protein extrudate is measured using a color-difference meter such as a Hunterlab calorimeter to obtain a color L value, a color A value, and a color B value.

Moisture Content. The term “moisture content” as used herein refers to the amount of moisture in a material. The moisture content of a soy material can be determined by A.O.C.S. (American Oil Chemists Society) Method Ba 2a-38 (1997), which is incorporated herein by reference in its entirety. Moisture content is calculated according to the formula: Moisture content (%)=100×[(loss in mass (grams)/mass of sample (grams)].

Texture. To measure the texture, a Stable Micro Systems Model TA-XT21 with 50 kg load cell is used. The sample to be tested is placed in the back extrusion rig and place it on the platform. The test is conducted by inserting a probe into the sample to a vertical distance of 68 mm. The hardness of the sample is measured by the force needed to advance the probe. When a 3 compression test is performed, the same sample is subjected to three successive measurements.

Fat Content. To measure fat content, an acid hydrolysis or ether extraction method is used. The acid hydrolysis method requires hydrolysis of the protein with an acid followed by extraction with ether. The fat content measured by acid hydrolysis is the preferred method of determining the fat content of the protein extrudate. The ether extraction method for determining fat content involved extracting fat from the protein extrudate without first hydrolyzing the protein with acid. The weight percentage of fat and other components recited herein for the protein extrudate of the invention do not include amounts added to the extrudate post-extrusion, such as fat added to an extrudate when it is coated with a flavorant.

Having described the invention in detail, it will be apparent that modifications and variations are possible without departing from the scope of the invention defined in the appended claims.

### EXAMPLES

The following non-limiting examples are provided to further illustrate the present invention.

### Example 1

### Preparation of Soy Protein Nuggets Containing Omega-3 Fatty Acids

Soy protein extrudates having approximately 65 to 70 wt. % protein were prepared. The feed mixtures are described below.

| | Formulations (%) | | | | | |
|---|---|---|---|---|---|---|
| Ingredients | 1 | 2 | 3 | 4 | 5 | 6 |
| SUPRO ® 8000 ISP | 60% | 60% | 60% | 60% | 50% | 75% |
| SUPRO ® 620 ISP | 20% | | 20% | | | 15% |
| SUPRO ® 248 | | 20% | | 20% | 30% | |
| Tapioca Starch | 20% | | | | 20% | |
| Rice Flour | | 20% | | | | |
| Pre-gelatinized Rice | | | 20% | 20% | | 10% |
| Flour PAC GEL | | | | | | |

To each dry formulation, an oil or oil emulsion was added at a load to make the oil 10 wt. % of the total dry solids weight. The oil used in the following experiments was Roche ROPUFA 30 fish oil containing 30% EPA+DHA by weight. When an oil emulsion was added, the following emulsion formulation was used.

| Ingredient | Weight % |
|---|---|
| EX-45 | 1.50 |
| Gum Arabic | 5.00 |
| Hydrolyzed pork gelatin | 10.00 |
| Water | 68.50 |
| Fish Oil | 13.39 |
| 1:1 Solec F/8160 Lecithin | 1.61 |

The ingredients of each feed mixture were mixed in an ingredient blender until uniformly distributed. The dry feed mixture was then conveyed to a Wenger TX52 extruder and processed using the following conditions. The formulation numbers in the table above are represented in the sample numbers as the last number in the sample ID; for example, formulation 1 was used in the first two sample IDs listed in the following table.

| | | | |
|---|---|---|---|
| | E100388-124- | E100388-124- | E100388-122- |
| Formula/Sample ID/Mix to use | 1A | 1B | 2A |

Extrusion Parameters

| | | | | |
|---|---|---|---|---|
| Dry Formula Feed Rate | (kg/hr) | 50 | 50 | 50 |
| Temperature Indicator | (° C.) | 24 | 24 | 24 |
| (Pre-con. Discharge Temp) | | | | |
| Extruder Percent Load | (%) | 65 | 65 | 71 |
| Extruder Shaft Speed | (RPM) | 462 | 463 | 506 |
| Pre-conditioner Speed | (RPM) | 711 | 711 | 700 |
| Knife Shaft Speed | (RPM) | 3054 | 3053 | 3020 |
| Temperature - Cone Head/Die | (° C.) | 106 | 107 | 106 |
| Temperature - Head #4 | (° C.) | 104 | 107 | 103 |
| Temperature - Head #3 | (° C.) | 74 | 82 | 61 |
| Temperature - Head #2 | (° C.) | 39 | 43 | 39 |
| Pressure - Cone Head | (PSI) | 700 | 675 | 700 |
| Pressure - Head #4 | (PSI) | 400 | 400 | 400 |
| Water Injection Head #2 | | 9.97 | 9.97 | 7.24 |
| (Pump Setting) | | | | |

Cutter and Die Information

| | | | | |
|---|---|---|---|---|
| Type of Cutter used | State | 6 blades | >> | >> |
| Type of Die used | State | 1.5 mm dia. | 3 holes>> | >> |

Tray Dryer Information

| | | | | |
|---|---|---|---|---|
| Temperature of the Dryer | (° F.) | 200 | 200 | 200 |
| Time in the Dryer | (min) | 30 + 15 | 30 + 15 | 30 + 15 |
| Final Product Moisture | (%) | 4.31 | 2.38 | 1.85 |

| | | | |
|---|---|---|---|
| | | E100388-124- | E100388- |
| Formula/Sample ID/Mix to use | E100388-124-2B | 5A | 124-5B |

Extrusion Parameters

| | | | | |
|---|---|---|---|---|
| Dry Formula Feed Rate | (kg/hr) | 50 | 50 | 50 |
| Temperature Indicator | (° C.) | 23 | 24 | 24 |
| (Pre-con. Discharge Temp) | | | | |
| Extruder Percent Load | (%) | 71 | 72 | 72 |
| Extruder Shaft Speed | (RPM) | 507 | 512 | 513 |
| Pre-conditioner Speed | (RPM) | 711 | 701 | 701 |
| Knife Shaft Speed | (RPM) | 3042 | 3021 | 3021 |
| Temperature - Cone Head/Die | (° C.) | 107 | 104 | 105 |
| Temperature - Head #4 | (° C.) | 108 | 102 | 107 |
| Temperature - Head #3 | (° C.) | 64 | 71 | 71 |
| Temperature - Head #2 | (° C.) | 38 | 39 | 39 |
| Pressure - Cone Head | (PSI) | 700 | 700 | 700 |
| Pressure - Head #4 | (PSI) | 400 | 400 | 400 |
| Water Injection Head #2 | | 7.25 | 8.32 | 8.32 |
| (Pump Setting) | | | | |

Cutter and Die Information

| | | | | |
|---|---|---|---|---|
| Type of Cutter used | State | 6 blades | >> | >> |
| Type of Die used | State | 1.5 mm dia. | >> | >> |

Tray Dryer Information

| | | | | |
|---|---|---|---|---|
| Temperature of the Dryer | (° F.) | 200 | 200 | 200 |
| Time in the Dryer | (min) | 30 + 15 | 30 + 15 | 30 + 15 |
| Final Product Moisture Target | (%) | 1.26 | 1.27 | 1.41 |

| | | | |
|---|---|---|---|
| | | | E100388- |
| Formula/Sample ID/Mix to use | E100388-124-3A | E100388-124-3B | 124-3C |

Extrusion Parameters

| | | | | |
|---|---|---|---|---|
| Dry Formula Feed Rate | (kg/hr) | 55 | 55 | 55 |
| Temperature Indicator | (° C.) | 24 | 25 | 25 |
| (Pre-con. Discharge Temp) | | | | |
| Extruder Percent Load | (%) | 58 | 58 | 58 |
| Extruder Shaft Speed | (RPM) | 416 | 414 | 417 |
| Pre-conditioner Speed | (RPM) | 782 | 785 | 783 |
| Knife Shaft Speed | (RPM) | 2956 | 2521 | 2833 |
| Temperature - Cone Head/Die | (° C.) | 111 | 117 | 115 |
| Temperature - Head #4 | (° C.) | 111 | 114 | 111 |
| Temperature - Head #3 | (° C.) | 101 | 101 | 101 |
| Temperature - Head #2 | (° C.) | 55 | 56 | 56 |
| Pressure - Cone Head | (PSI) | 600 | 600 | 600 |
| Pressure - Head #4 | (PSI) | 400 | 400 | 400 |
| Water Injection Head #2 | | 7.0 | 7.4 | 5.54 |
| (Pump Setting) | | | | |

Cutter and Die Information

| | | | | |
|---|---|---|---|---|
| Type of Cutter used | State | 6 blades | >> | >> |
| Type of Die used | State | 1.5 mm dia. | >> | >. |

Tray Dryer Information

| | | | | |
|---|---|---|---|---|
| Temperature of the Dryer | (° F.) | 200 | 200 | 200 |
| Time in the Dryer | (min) | 45 | 45 | 45 |
| Final Product Moisture Target | (%) | 3.60 | 2.06 | 1.98 |

| | | | |
|---|---|---|---|
| | | | E100388-124- |
| Formula/Sample ID/Mix to use | E100388-124-3D | E100388-124-4A | 4B |

Extrusion Parameters

| | | | | |
|---|---|---|---|---|
| Dry Formula Feed Rate | (kg/hr) | 55 | 55 | 55 |
| Temperature Indicator | (° C.) | 25 | 25 | 25 |
| (Pre-con. Discharge Temp) | | | | |
| Extruder Percent Load | (%) | 58 | 59 | 58 |
| Extruder Shaft Speed | (RPM) | 415 | 414 | 416 |
| Pre-conditioner Speed | (RPM) | 784 | 784 | 784 |
| Knife Shaft Speed | (RPM) | 2835 | 2835 | 2835 |
| Temperature - Cone Head/Die | (° C.) | 116 | 114 | 112 |
| Temperature - Head #4 | (° C.) | 112 | 111 | 108 |
| Temperature - Head #3 | (° C.) | 102 | 100 | 99 |
| Temperature - Head #2 | (° C.) | 55 | 56 | 56 |
| Pressure - Cone Head | (PSI) | 600 | 500 | 500 |
| Pressure - Head #4 | (PSI) | 400 | 300 | 400 |
| Water Injection Head #2 | | 5.54 | 8.84 | 8.84 |
| (Pump Setting) | | | | |

Cutter and Die Information

| | | | | |
|---|---|---|---|---|
| Type of Cutter used | State | 6 blades | >> | >> |
| Type of Die used | State | 1.5 mm dia. | >> | >> |

Tray Dryer Information

| | | | | |
|---|---|---|---|---|
| Temperature of the Dryer | (° F.) | 200 | 200 | 200 |
| Time in the Dryer | (min) | 45 | 45 | 45 |
| Final Product Moisture Target | (%) | 1.89 | 2.35 | 2.17 |

| | | | |
|---|---|---|---|
| | | | E100388-124- |
| Formula/Sample ID/Mix to use | E100388-124-4C | E100388-124-4D | 6A |

Extrusion Parameters

| | | | | |
|---|---|---|---|---|
| Dry Formula Feed Rate | (kg/hr) | 55 | 55 | 55 |
| Temperature Indicator | (° C.) | 25 | 25 | 26 |
| (Pre-con. Discharge Temp) | | | | |
| Extruder Percent Load | (%) | 58 | 59 | 58 |
| Extruder Shaft Speed | (RPM) | 415 | 416 | 415 |
| Pre-conditioner Speed | (RPM) | 784 | 784 | 783 |
| Knife Shaft Speed | (RPM) | 2836 | 2836 | 2837 |
| Temperature - Cone Head/Die | (° C.) | 110 | 112 | 113 |
| Temperature - Head #4 | (° C.) | 106 | 108 | 111 |
| Temperature - Head #3 | (° C.) | 98 | 100 | 101 |
| Temperature - Head #2 | (° C.) | 56 | 55 | 58 |
| Pressure - Cone Head | (PSI) | 500 | 500 | 600 |
| Pressure - Head #4 | (PSI) | 400 | 400 | 400 |
| Water Injection Head #2 | | 4.3 | 7.92 | 8.95 |
| (Pump Setting) | | | | |

Cutter and Die Information

| | | | | |
|---|---|---|---|---|
| Type of Cutter used | State | 6 blades | >> | >> |
| Type of Die used | State | 1.5 mm dia. | >> | >> |

Tray Dryer Information

| | | | | |
|---|---|---|---|---|
| Temperature of the Dryer | (° F.) | 200 | 200 | 200 |
| Time in the Dryer | (min) | 45 | 45 | 45 |
| Final Product Moisture Target | (%) | 2.54 | 2.05 | 1.55 |

| Formula/Sample ID/Mix to use | | E100388-124-6B | E100388-124-6E |
|---|---|---|---|
| Dry Formula Density | (g/cc) | — | — |
| Dry Formula Moisture Content | (%) | — | — |

Extrusion Parameters

| | | | |
|---|---|---|---|
| Dry Formula Feed Rate | (kg/hr) | 55 | 55 |
| Temperature Indicator | (° C.) | 26 | 26 |
| (Pre-con. Discharge Temp) | | | |
| Extruder Percent Load | (%) | 58 | 56 |
| Extruder Shaft Speed | (RPM) | 415 | 414 |
| Pre-conditioner Speed | (RPM) | 783 | 785 |
| Knife Shaft Speed | (RPM) | 2837 | 3061 |
| Temperature - Cone Head/Die | (° C.) | 113 | 110 |
| Temperature - Head #4 | (° C.) | 111 | 109 |
| Temperature - Head #3 | (° C.) | 100 | 100 |
| Temperature - Head #2 | (° C.) | 56 | 54 |
| Pressure - Cone Head | (PSI) | 600 | 500 |
| Pressure - Head #4 | (PSI) | 400 | 400 |
| Water Injection Head #2 | | 9.74 | 6.5 |
| (Pump Setting) | | | |

Cutter and Die Information

| | | | |
|---|---|---|---|
| Type of Cutter used | State | 6 blades | >> |
| Type of Die used | State | 1.5 mm dia. | >> |

Tray Dryer Information

| | | | |
|---|---|---|---|
| Temperature of the Dryer | (° F.) | 200 | 200 |
| Time in the Dryer | (min) | 45 | 45 |
| Final Product Moisture Target | (%) | 1.72 | 2.67 |

| | | | | | Input - Conveying- |
|---|---|---|---|---|---|
| | | | | | Compression, |
| | | | | Input Numbers | Mixing - |
| | | | Input Numbers | of Screw to be | shearing or Die |
| | | | to be used | used | Head, |
| | Position | | LEFT SHAFT | RIGHT SHAFT | Function |
| Screw Profile Parameters | | | | | |
| Used on Day One | | | | | |
| Inlet | | | 55357-203 | 55357-003 | Conveying |
| | | | 55357-203 | 55357-003 | ″ |
| | | | 55357-103 | 55357-103 | ″ |
| | 0 | deg | 55324-101 | 55324-101 | Mixing/shearing |
| | 45 | deg F. | 55324-103 | 55324-103 | ″ |
| | 45 | deg F. | 55324-105 | 55324-105 | ″ |
| | | | 55357-103 | 55357-103 | Conveying |
| | | | 55325-103 | 55325-103 | Compressing |
| | | | 55326-103 | 55326-103 | ″ |
| | 0 | deg | 55324-101 | 55324-101 | Mixing/shearing |
| | 45 | deg R | 55324-103 | 55324-103 | ″ |
| | 45 | deg R | 55324-105 | 55324-105 | ″ |
| | 0 | deg | 44324-105 | 44324-105 | ″ |
| | 45 | deg F. | 55324-103 | 55324-103 | |
| | 45 | deg F. | 55324-001 | 55324-001 | |
| | 0 | deg | 55357-003 | 55357-003 | Conveying |
| | | | 55235-003 | 55235-003 | Compressing |
| | | | 55321-005 | 55321-005 | Compressing |
| Screw Profile Parameters | | | | | |
| Used on Day two. | | | | | |
| Inlet | | | 55357-203 | 55357-003 | Conveying |
| | | | 55357-203 | 55357-003 | ″ |
| | | | 55357-103 | 55357-103 | ″ |
| | 0 | deg | 55324-101 | 55324-101 | Mixing/shearing |
| | 45 | deg F. | 55324-103 | 55324-103 | ″ |
| | 45 | deg F. | 55324-105 | 55324-105 | ″ |
| | | | 55357-003 | 55357-003 | Conveying |
| | | | 55325-103 | 55325-103 | Compressing |
| | | | 55326-007 | 55326-007 | ″ |
| | 0 | deg | 55324-101 | 55324-101 | Mixing/shearing |
| | 45 | deg R | 55324-103 | 55324-103 | ″ |
| | 45 | deg R | 55324-105 | 55324-105 | ″ |
| | | | 55326-007 | 55326-007 | Compressing |
| | 0 | deg | 55324-101 | 55324-101 | Mixing/shearing |
| | 45 | deg R | 55324-103 | 55324-103 | ″ |
| | 45 | deg R | 55324-105 | 55324-105 | ″ |
| | 0 | deg | 55324-105 | 55324-105 | |
| | 45 | deg F. | 55324-103 | 55324-103 | |
| | 45 | deg F. | 55324-101 | 55324-101 | |
| | | | 55321-007 | 55321-007 | Mixing/shearing |

Die Configuration

| | | | | | |
|---|---|---|---|---|---|
| PRPHL Die | | | | | |
| Die Insert | a)1.5 mm | Diameter | 3 holes w/1/8 | back plate | |
| Adapter/spacer | | Y adapter | 55361-9 | Ring spacer | 55372-719 |

Knife Configuration

| | | |
|---|---|---|
| Knife holder | 55226-003 | |
| 6 Knife blades | New flexible | blades design |

Dryer Parameters.

| | Drying temp. | | Drying Time | Moisture (%) |
|---|---|---|---|---|
| Sample ID: | (F.) | Trial Day | Minutes | IR-120 MA |
| 1. E100388-124-1A | 200 | 1 | 30 + 15 | 3.31 |
| 2. E100388-124-1B | 200 | 1 | 30 + 15 | 2.38 |
| 3. E100388-124-2A | 200 | 1 | 30 + 15 | 1.85 |
| 4. E100388-124-2B | 200 | 1 | 30 + 15 | 1.26 |
| 5. E100388-124-5A | 200 | 1 | 30 + 15 | 1.27 |
| 6. E100388-124-5B | 200 | 1 | 30 + 15 | 1.41 |
| 7. E100388-124-3A | 200 | 2 | 45 | 3.60 |
| 8. E100388-124-3B | 200 | 2 | 45 | 2.06 |
| 9. E100388-124-3C | 200 | 2 | 45 | 1.98 |
| 10. E100388-124-3D | 200 | 2 | 45 | 1.89 |
| 11. E100388-124-4A | 200 | 2 | 45 | 2.35 |
| 12. E100388-124-4B | 200 | 2 | 45 | 2.17 |
| 13. E100388-124-4C | 200 | 2 | 45 | 2.54 |
| 14. E100388-124-4D | 200 | 2 | 45 | 2.05 |
| 15. E100388-124-6A | 200 | 2 | 45 | 1.55 |
| 16. E100388-124-6B | 200 | 2 | 45 | 1.72 |
| 17. E100388-124-6E | 200 | 2 | 45 | 2.67 |

The protein extrudates produced had the following characteristics. The PV is the peroxide value in units of meq/kg. TBA is trenbalone acetate in units of ppm. The fat content measured by acid hydrolysis (AH Fat %) and measured by ether extraction (EE Fat %) are also detailed.

| | | | | | | | Kjeldal | | |
|---|---|---|---|---|---|---|---|---|---|
| | | | | | | Moisture | Protein | | |
| | | Corresponding | | TBA | | Content | (%, | AH Fat | EE Fat |
| | Sample # | Sample | PV (avg) | (ppm) | ash (%) | (%) | N = 6.25) | (%) | (%) |
| Roche Fish Oil Addition | | | | | | | | | |
| at the Extruder Inlet | | | | | | | | | |
| Sample 5 Roche Fish Oil | E107958-10-01 | 5 Oven FISH | 32.00 | 2.65 | 3.03 | 2.74% | 66.3 | 10.00% | 5.17% |
| Oven Dried | | | | | | | | | |
| Sample 2 Roche Fish Oil | E107958-10-02 | 2 Oven FISH | 18.90 | 2.20 | 3.1 | 3.12% | 66.5 | 10.40% | 7.33% |
| Oven Dried | | | | | | | | | |
| Sample 1 Roche Fish Oil | E107958-10-03 | 1 Oven FISH | 14.30 | 2.67 | 2.89 | 4.57% | 65.1 | 9.76% | 6.87% |
| Oven Dried | | | | | | | | | |
| Sample 5 Roche Fish Oil | E107958-10-05 | 5 Freeze FISH | 18.10 | 2.30 | 2.94 | 5.85% | 64.1 | 9.55% | 4.66% |
| Freeze Dried | | | | | | | | | |
| Sample 5 Roche Fish Oil | E107958-10-06 | 5 Not Dried FISH | 41.70 | 2.74 | 1.98 | 35.50% | 43.6 | 7.07% | 2.97% |
| Not Dried | | | | | | | | | |
| Sample 5 Soybean Oil | E107958-10-07 | 5 Oven SOY | 14.00 | 2.75 | 3.06 | 2.98% | 64.6 | 9.97% | 5.24% |
| Oven Dried | | | | | | | | | |
| Sample 2 Soybean Oil | E107958-10-08 | 2 Oven SOY | 8.85 | 2.31 | 3.06 | 3.00% | 67.1 | 9.92% | 6.67% |
| Oven Dried | | | | | | | | | |
| Sample 1 Soybean Oil | E107958-10-09 | 1 Oven SOY | 11.30 | 2.06 | 2.98 | 4.16% | 66.2 | 9.37% | 4.95% |
| Oven Dried | | | | | | | | | |
| Addition of Roche Fish Oil | | | | | | | | | |
| Coacervate (FP-01297 | | | | | | | | | |
| #10 10% Lecithin) at | | | | | | | | | |
| the Extruder Inlet | | | | | | | | | |
| Sample 3 Roche Fish Oil | E107958-10-11 | 3 Oven FISH | 19.6 | 1.83 | | 3.34% | | | 6.28% |
| Oven Dried | | | | | | | | | |
| Sample 3 Roche Fish Oil | E107958-10-12 | 3 Oven FISH F1 | 46.2 | 1.32 | | 3.11% | | | 3.05% |
| Coacervate Oven Dried | | Coac. | | | | | | | |
| Sample 3 Roche Fish Oil | E107958-10-13 | 3 Oven FISH F2 | 45.2 | 1.86 | | 3.19% | | | 2.68% |
| Coacervate 75 ppm TBHQ | | Coac. | | | | | | | |
| Oven Dried | | | | | | | | | |
| Sample 4 Roche Fish Oil | E107958-10-14 | 4 Oven FISH | 62.0 | 1.35 | | 3.55% | | | 4.55% |
| Oven Dried | | | | | | | | | |
| Sample 4 Roche Fish Oil | E107958-10-15 | 4 Oven FISH F1 | 56.6 | 1.72 | | 3.83% | | | 2.00% |
| Coacervate F1 Oven Dried | | Coac. | | | | | | | |
| Sample 4 Roche Fish Oil | E107958-10-16 | 4 Oven FISH F2 | 119.0 | 1.36 | | 3.71% | | | 2.17% |
| Coacervate F2 Oven Dried | | Coac. | | | | | | | |
| Sample 6 Roche Fish Oil | E107958-10-17 | 6 Oven FISH | 31.0 | 2.32 | | 3.04% | | | 9.01% |
| Oven Dried | | | | | | | | | |
| Sample 6 Roche Fish Oil | E107958-10-18 | 6 Oven FISH F3 | 45.2 | 2.43 | | 3.48% | | | 5.63% |
| Coacervate 200 ppm | | Coac. | | | | | | | |
| TBHQ Oven Dried | | | | | | | | | |
| Sample 3 Soybean Oil | E107958-10-19 | 3 Oven SOY | 28.6 | 2.11 | | 3.52% | | | 6.25% |
| Oven Dried | | | | | | | | | |
| Sample 4 Soybean Oil | E107958-10-20 | 4 Oven SOY | 16.3 | 2.03 | | 3.59% | | | 4.09% |
| Oven Dried | | | | | | | | | |
| Sample 6 Soybean Oil | E107958-10-21 | 6 Oven SOY | 10.2 | 1.80 | | 2.86% | | | 8.30% |
| Oven Dried | | | | | | | | | |

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above particles and processes without departing from the scope of the invention, it is intended that all matter contained in the above description and shown in the accompanying drawings shall be interpreted as illustrative and not in a limiting sense.

1. A protein extrudate comprising at least 50 wt. % vegetable protein on a moisture-free basis, and from about 5 wt. % to about 15 wt. % oil on a moisture-free basis, wherein the oil comprises at least 10 wt. % of the at least one omega-3 fatty acid based upon the total weight of fatty acids or derivatives thereof in the oil, the extrudate having a density from about 0.02 to about 0.5 g/cm³.

2. The protein extrudate of claim 1 wherein the oil comprises at least 15 wt. % of the at least one omega-3 fatty acid based upon the total weight of fatty acids or derivatives thereof in the oil.

3. The protein extrudate of claim 1 wherein the oil comprises at least 25 wt. % of the at least one omega-3 fatty acid based upon the total weight of fatty acids or derivatives thereof in the oil.

4. The protein extrudate of claim 1 further comprising from about 5 wt. % to about 15 wt. % of a modified starch, a pre-gelatinized starch, a pre-gelatinized rice flour, or a combination thereof.

5. The protein extrudate of claim 1 wherein the vegetable protein comprises soy protein and the at least one omega-3 fatty acid comprises α-linolenic acid, stearidonic acid, eicosatetraenoic acid, eicosapentaenoic acid, docosapentaenoic acid, docosahexaenoic acid, or a mixture thereof.

6. The protein extrudate of claim 5 containing at least 60 wt. % soy protein.

7. The protein extrudate of claim 5 containing at least 70 wt. % soy protein.

8. The protein extrudate of claim 1 having a density from about 0.15 to about 0.25 g/cm³.

9. The protein extrudate of claim 1 wherein the vegetable protein comprises at least about 2 parts by weight hydrolyzed vegetable protein per part by weight unhydrolyzed vegetable protein, the hydrolyzed vegetable protein having a degree of hydrolysis of less than about 5%.

10. A protein extrudate comprising at least 50 wt. % vegetable protein on a moisture-free basis, and at least 10 wt. % oil on a moisture-free basis, wherein the oil comprises at least 10 wt. % of the at least one omega-3 fatty acid based upon the total weight of fatty acids or derivatives thereof in the oil, the extrudate having a density from about 0.02 to about 0.5 g/cm³, and a hardness from about 7,000 to about 30,000 grams, as measured by a texture analyzer having a 25 kg load cell.

11. The protein extrudate of claim 10 comprising from about 10 wt. % to about 15 wt. % of the oil.

12. The protein extrudate of claim 10 wherein the extrudate is a nugget having a crispiness of from about 5 to about 9, as measured by peak count using a texture analyzer.

13. The protein extrudate of claim 10 wherein the vegetable protein comprises at least about 2 parts by weight hydrolyzed vegetable protein per part by weight unhydrolyzed vegetable protein, the hydrolyzed vegetable protein having a degree of hydrolysis of less than about 5%.

14. A food product comprising the protein extrudate of claim 1.

15. The food product of claim 14 wherein the food product is a low density snack food.

16. The food product of claim 15 wherein the low density snack food is a snack puff or a breakfast cereal.

17. A method of making a protein extrudate comprising:
mixing vegetable protein, an oil comprising at least 10 wt. % of at least one omega-3 fatty acid based upon the total weight of fatty acids or derivatives thereof in the oil, and water in an extruder to form a mixture;
pressurizing the mixture in the extruder to a pressure of at least about 400 psi to form a pressurized mixture;
heating the pressurized mixture in the extruder to a temperature of at least 35° C. to form a heated and pressurized mixture;
extruding the heated and pressurized mixture through an extruder die to a reduced pressure environment to expand the mixture and form an extrudate;
cutting the extrudate into a plurality of pieces; and
drying the pieces to a water content of from about 1 wt. % to about 7 wt. % to form the protein extrudate having a density from about 0.02 g/cm³ to about 0.5 g/cm³ based on the weight of the protein extrudate and comprising from about 50 wt. % to about 85 wt. % protein.

18. The method of claim 17 wherein the oil comprises at least 15 wt. % of the at least one omega-3 fatty acid based upon the total weight of fatty acids or derivatives thereof in the oil.

19. The method of claim 17 wherein the oil comprises at least 25 wt. % of the at least one omega-3 fatty acid based upon the total weight of fatty acids or derivatives thereof in the oil.

20. The method of claim 17 wherein the vegetable protein comprises soy protein and the at least one omega-3 fatty acid comprises α-linolenic acid, stearidonic acid, eicosatetraenoic acid, eicosapentaenoic acid, docosapentaenoic acid, docosahexaenoic acid, or a mixture thereof.

21. The method of claim 17 wherein the protein extrudate contains at least 60 wt. % soy protein.

22. The method of claim 17 wherein the protein extrudate contains at least 70 wt. % soy protein.

23. The method of claim 17 wherein the protein extrudate has a density from about 0.15 to about 0.25 g/cm³.

24. The method of claim 17 wherein the oil is an oil-in-water emulsion.

25. The method of claim 17 wherein the mixture further comprises a modified starch, a pre-gelatinized starch, a pre-gelatinized rice flour, or a combination thereof.
